(19) United States
(12) Patent Application Publication
(10) Pub. No.: US 2025/0142647 A1
(43) Pub. Date: May 1, 2025

(54) METHOD FOR PROCESSING DATA, COMMUNICATION DEVICE AND CHIP

(71) Applicant: GUANGDONG OPPO MOBILE TELECOMMUNICATIONS CORP., LTD., Dongguan (CN)

(72) Inventors: Shukun WANG, Dongguan (CN); Zhongda DU, Dongguan (CN); Cong SHI, Dongguan (CN)

(21) Appl. No.: 19/004,739

(22) Filed: Dec. 30, 2024

Related U.S. Application Data
(63) Continuation of application No. PCT/CN2022/105541, filed on Jul. 13, 2022.

(51) Int. Cl. H04W 76/11; H04L 1/1822; H04L 69/22

(52) U.S. Cl. CPC H04W 76/11; H04L 1/1822; H04L 69/22

(57) ABSTRACT

A method for processing data, a communication device and a chip are provided. The method includes the following operations. A node processes data by means of protocol entities of a bearer, and the bearer has at least one of the following characteristics: at least two protocol entities of the bearer are protocol entities of the same type in different modes; the function of at least one protocol entity of the bearer can change dynamically or semi-statically; and the protocol entities of the bearer include a target entity, and the target entity having at least some of the functions of a packet data convergence protocol (PDCP) entity and/or a radio link control (RLC) entity.

### CROSS-REFERENCE TO RELATED APPLICATION

This is a continuation application of International Patent Application No. PCT/CN2022/105541, filed on Jul. 13, 2022, the disclosure of which is hereby incorporated by reference in its entirety.

### RELATED ART

Compared with the application scenarios of 5th Generation Mobile Communication Technology (5G), the application scenarios of future communication standards (such as 6th Generation Mobile Communication Technology (6G)) will have more diversified characteristics. In order to meet the more diversified characteristics of application scenarios, access network resources should be more flexible.

The bearer, as an access network resource, cannot have the diversified characteristics of application scenarios according to the definition of the current communication standards (such as 5G). At present, the bearer defined by the communication standard lacks flexibility and needs to be redefined.

### SUMMARY

The embodiments of the present disclosure relate to the technical field of mobile communication, and particularly relate to a method for processing data, a communication device and a chip.

The method for processing data according to the embodiment of the present disclosure includes the following operations.

A node processes data by protocol entities of a bearer. The bearer has at least one of the following characteristics.

At least two protocol entities of the bearer are protocol entities of the same type in different modes.

A function of at least one protocol entity of the bearer can change dynamically or semi-statically.

The protocol entities of the bearer include a target entity, and the target entity has at least part of functions of a packet data convergence protocol (PDCP) entity and/or a radio link control (RLC) entity.

The communication device according to the embodiment of the present disclosure includes a processor and a memory for storing a computer program.

The processor is configured for invoking and executing the computer program stored in the memory to cause the communication device to process data by protocol entities of a bearer, and the bearer has at least one of the following characteristics.

At least two protocol entities of the bearer are protocol entities of the same type in different modes.

A function of at least one protocol entity of the bearer is able to change dynamically or semi-statically.

The protocol entities of the bearer include a target entity, and the target entity has at least part of functions of a PDCP entity and/or an RLC entity.

The chip according to the embodiment of the present disclosure is used for implementing the above-described method for processing data.

Specifically, the chip includes a processor for invoking and executing a computer program from a memory, to enable a device on which the chip is mounted to perform the above-described method for processing data.

### BRIEF DESCRIPTION OF THE DRAWINGS

The accompanying drawings described herein are intended to provide a further understanding of the present disclosure, and constitute a part of the present disclosure, and the schematic embodiments of the present disclosure and the description thereof are intended to explain the present disclosure, and do not constitute an undue limitation of the present disclosure. In the accompanying drawings:

FIG. 1 is a schematic architecture diagram of a communication system according to an embodiment of the present disclosure.

FIG. 2 is a first schematic flowchart of a method for processing data according to an embodiment of the present disclosure.

FIG. 3 is a first schematic diagram of a protocol stack according to an embodiment of the present disclosure.

FIG. 4 is a schematic diagram of a PDCP packet header according to an embodiment of the present disclosure.

FIG. 5 is a second schematic diagram of a protocol stack according to an embodiment of the present disclosure.

FIG. 6 is a third schematic diagram of a protocol stack according to an embodiment of the present disclosure.

FIG. 7A is a first schematic diagram of a data processing process of a PPLC entity according to an embodiment of the present disclosure.

FIG. 7B is a second schematic diagram of a data processing process of a PPLC entity according to an embodiment of the present disclosure.

FIG. 8 is a fourth schematic diagram of a protocol stack according to an embodiment of the present disclosure.

FIG. 9 is a second schematic flowchart of a method for processing data according to an embodiment of the present disclosure.

FIG. 10 is a fifth schematic diagram of a protocol stack according to an embodiment of the present disclosure.

FIG. 11 is a first schematic diagram of the structure and composition of a device for processing data according to an embodiment of the present disclosure.

FIG. 12 is a second schematic diagram of the structure and composition of a device for processing data according to an embodiment of the present disclosure.

FIG. 13 is a schematic structural diagram of a communication device according to an embodiment of the present disclosure.

FIG. 14 is a schematic structural diagram of a chip according to an embodiment of the present disclosure.

FIG. 15 is a schematic block diagram of a communication system according to an embodiment of the present disclosure.

### DETAILED DESCRIPTION

Hereinafter, the technical solutions in the embodiments of the present disclosure will be described with reference to the accompanying drawings in the embodiments of the present disclosure, and it is apparent that the described embodiments are part of the embodiments of the present disclosure, rather than all of the embodiments. Based on the embodiments in the present disclosure, all other embodiments obtained by those skilled in the art without creative work fall within the scope of protection of the present disclosure.

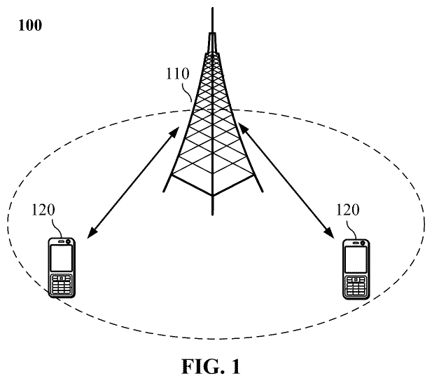

FIG. 1 is a schematic architecture diagram of a communication system according to an embodiment of the present disclosure. As shown in FIG. 1, the communication system 100 may include a network device 110, which may be a device that communicates with a terminal device 120 (or referred to as a communication terminal, a terminal). The network device 110 may provide communication coverage for a particular geographic area and may communicate with terminal devices located within the coverage area.

FIG. 1 exemplarily illustrates one network device and two terminal devices. In some embodiments of the present disclosure, the communication system 100 may include a plurality of network devices and another number of terminal devices may be included within the coverage range of each network device, which is not limited in the embodiments of the present disclosure.

The terminal device in FIG. 1 may be any terminal device. For example, the terminal device may be an access terminal, a user equipment (UE), a user unit, a user station, a mobile station, a mobile unit, a remote station, a remote terminal, a mobile device, a user terminal, a terminal, a wireless communication device, a user agent, or a user device. The access terminal may be a cellular telephone, a cordless telephone, a session initiation protocol (SIP) telephone, an internet of things (IoT) device, a satellite handheld terminal, a wireless local loop (WLL) station, a personal digital assistant (PDA), a handheld device having wireless communication functionality, a computing device or other processing device connected to a wireless modem, an in-vehicle device, a wearable device, a terminal device in a 5G network or a terminal device in a future evolution network, or the like.

It should be noted that FIG. 1 only illustrates a system to which the present disclosure is applied as an example, and of course, the method shown in the embodiment of the present disclosure may also be applied to other systems. Furthermore, the terms “system” and “network” are often used interchangeably herein. Herein, the term “and/or” is only an association relationship describing an association object, and means that there may be three relationships. For example, A and/or B may mean that A alone exists, A and B simultaneously exist, and B alone exists. In addition, the character “/” herein generally indicates that the related objects before and after are in an “or” relationship. It should also be understood that the “indication” mentioned in the embodiments of the present disclosure may be a direct indication, an indirect indication, or an associated relationship. For example, A indicates B, which may mean that A directly indicates B, for example, B can be acquired by A; which may also mean that A indicates B indirectly, for example A indicates C, and B can be acquired through C; which may also indicate that there is an association relationship between A and B. It should also be understood that “correspondence” mentioned in the embodiments of the present disclosure may indicate that there is a direct correspondence or indirect correspondence between the two objects, there is an association relationship between the two objects, or the two objections have a relationship between indicating and being indicated, configuring and being configured, or the like. It should also be understood that the “predefined” or “predefined rules” mentioned in the embodiments of the present disclosure may be implemented by storing corresponding codes, tables, or other methods for indicating relevant information in advance in devices (e.g., including terminal devices and network devices), and the present disclosure does not limit specific implementations thereof. For example, pre-definition may refer to definition in the protocol. It should also be understood that in the embodiment of the present disclosure, the “protocol” may refer to a standard protocol in the communication field, and may include, for example, an LTE protocol, an NR protocol, and related protocols applied in future communication systems, which is not limited in the present disclosure.

In order to facilitate understanding of the technical solutions of the embodiments of the present disclosure, the related technologies of the embodiments of the present disclosure will be described below, and the related technologies below can be, as optional solutions, arbitrarily combined with the technical solutions of the embodiments of the present disclosure, and all of them belong to the scope of protection of the embodiments of the present disclosure.

In long term evolution (LTE), a DBR identity of a dedicated data radio bearer (DRB) is associated with a packet data convergence protocol (PDCP) configuration, a radio link control (RLC) configuration, and a logical channel configuration belonging to the DRB. In LTE dual connectivity (LTE DC), the DRB identifier is also associated with an RLC configuration, a logical channel configuration, and the like on a secondary cell group (SCG) side belonging to the DRB.

In a new radio (NR), a DBR identity of a dedicated DRB is associated with a PDCP configuration, an RLC configuration, a logical channel configuration belonging to the DRB, and a service data adaption protocol (SDAP) configuration to which the DRB belongs. It should be noted that the SDAP entity is at the PDU session level.

Whether in LTE or NR, once a bearer (i.e. DRB) is established, the PDCP configuration and RLC configuration of the bearer do not change.

On the one hand, the data in a bearer may have different requirements for quality of service (Qos), and thus may require different processing methods. For example, for extended reality (XR) services, the data in one bearer includes I-frames, P-frames, and B-frames. I-frames, P-frames, and B-frames have different importance levels, and I-frames have higher importance level than P-frames and B-frames. Therefore, the Qos requirements of I-frames are different from those of P/B-frames.

On the other hand, the security processing function of a bearer is turned on or turned off per bearer, and the security processing function includes, for example, encryption function and integrity protection function. Once a bearer turns on the security processing function, all data on the bearer are securely processed. Once the security processing function of a bearer is turned off, all data on the bearer are not securely processed. If all the data on a bearer is securely processed, the data transmission rate may be reduced due to limited data processing efficiency. If the data on a bearer is selectively securely processed, the purpose of protecting data security without affecting the data transmission rate can be achieved. In addition, in the current solution, the security processing function of a bearer may be turned on or turned off with reconfiguration, that is, L2 reconstruction and reset, and it is impossible to dynamically turn on or turn off the security processing function of a bearer.

Compared with the three major application scenarios (enhanced mobile broadband (eMBB), ultra-reliable low-latency communications (URLLC), and massive machine-type communications (mMTC)) of the 5G, the application scenarios of future communication standards (such as 6G) may have more diversified characteristics, which requires supporting one or all of Qos requirements for multiple services such as large bandwidth, large connection, low latency, deterministic latency, and high-precision sensing. Therefore, the network should have the agile ability and can be intelligently responsive to emerging business requirements. These requirements not only include bandwidth, delay, connection number, coverage and other indicators requirements, but also include flexible arrangement of access network resources to realize intelligent network functions and flexible management of network functions.

The currently defined bearer lacks flexibility and needs to be redefined according to new scenarios, new services and new requirements of future communication standards (such as 6G). Therefore, the following technical solutions according to the embodiments of the present disclosure are proposed.

In order to facilitate understanding of the technical solutions of the embodiments of the present disclosure, the technical solutions of the present disclosure will be described in detail below with reference to specific examples. The above related technologies can be as optional solutions arbitrarily combined with the technical solutions of the embodiments of the present disclosure, and all of them are within the scope of protection of the embodiments of the present disclosure. The embodiments of the present disclosure include at least some of the following contents.

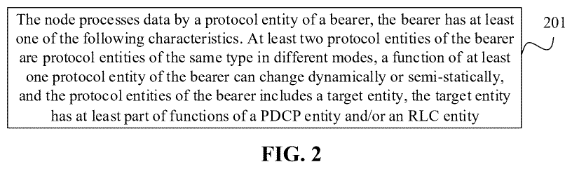

FIG. 2 is a first schematic flowchart of a method for processing data according to an embodiment of the present disclosure. As shown in FIG. 2, the method for processing data includes the following operations 201.

At 201, the node processes data by a protocol entity of a bearer. The bearer has at least one of the following characteristics. At least two protocol entities of the bearer are protocol entities of the same type in different modes. A function of at least one protocol entity of the bearer can change dynamically or semi-statically. The protocol entity of the bearer includes a target entity, and the target entity has at least part of the functions of a PDCP entity and/or a RLC entity.

The technical solution of the embodiment of the present disclosure is applied to a node, and the node may be a network device or a terminal device.

In the embodiment of the present disclosure, the protocol entity of the bearer has the following two implementation modes.

In a first mode, the protocol entity of the bearer includes at least one of the following: a PDCP entity and an RLC entity.

Herein, the function of the PDCP entity may be defined with reference to the target standard. For example, the function of the PDCP entity include at least one of a header compression function, an integrity protection function, an encryption and decryption function, a serial number (SN) and reordering function.

The SN and reordering function of the PDCP entity refer to an SN addition function and an SN-based reordering function of the PDCP entity. The SN of the PDCP entity refers to the PDCP SN.

Herein, the function of the RLC entity may be defined with reference to the target standard. For example, the function of the RLC entity includes at least one of an automatic repeat-request (ARQ) function, a segmentation function, an SN and reordering function.

The SN and reordering function of the RLC entity refer to an SN addition function and an SN-based reordering function of the RLC entity. The SN of the RLC entity refers to the RLC SN.

In some embodiments, in order to support low-latency service, the RLC entity introduces a pre-processing function. That is, the RLC entity in the unacknowledged mode (UM) may not add an SN to the data without segmenting the data. The RLC entity in acknowledged mode (AM) supports the ARQ function, and supports the SN and reordering function.

In some embodiments, the protocol entity of the bearer includes an RLC entity in a first mode and an RLC entity in a second mode. The RLC entity in the first mode is configured to process data having the first attribute information, and the RLC entity in the second mode is configured to process data having the second attribute information.

As an example, the first mode is the AM and the second mode is the UM mode. Alternatively, the first mode is the UM mode and the second mode is the AM mode.

In some embodiments, the first attribute information includes at least one of a first Qos attribute, a first data type, a first importance level, and the first data priority. The second attribute information includes at least one of a second Qos attribute, a second data type, a second importance level, and the second data priority. Herein, the first Qos attribute is, for example, that packet loss is not allowed or that acknowledgement (ACK)/negative acknowledgement (NACK) feedback is required. The second Qos attribute is, for example, that packet loss is allowed or that ACK/NACK feedback is not required. Herein, the first data type is, for example, an I-frame. The second data type is, for example, a B-frame and/or a P-frame. The first importance level, for example, a high importance level. The second importance level is, for example, a low importance level. The first data priority is, for example, a high priority. The second data priority is, for example, a low priority.

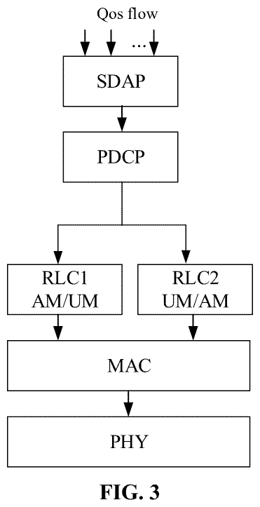

In one example, as shown in FIG. 3, the protocol entities of the bearer include one PDCP entity and two RLC entities (i.e., RLC entity 1 and RLC entity 2), and the modes of the two RLC entities are different. That is, one PDCP entity is associated with two RLC entities in different modes. For example, the mode of the RLC entity 1 is the AM and the mode of the RLC entity 2 is the UM, or the mode of the RLC entity 1 is the UM and the mode of the RLC entity 2 is the AM. The data in a Qos flow has different attribute information, and the PDCP entity distributes the data to different RLC entities according to the attribute information of the data. For example, the PDCP entity provides the data having the first attribute information to the RLC entity in the mode AM, and the PDCP entity provides the data having the second attribute information to the RLC entity in the mode UM.

In some embodiments, the PDCP packet header corresponding to the data carries first indication information and/or second indication information. The first indication information indicates whether the data is subject to encryption processing, and the second indication information indicates whether the data is subject to integrity protection processing. The PDCP packet header is a packet header corresponding to the PDCP entity.

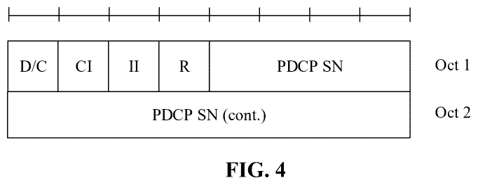

In one example, as shown in FIG. 4, two pieces of indication information are carried in the PDCP packet header. The CI field represents the first indication information. The CI field is set to 1 to indicate that the encryption function is turned on for the data (that is, encryption processing is performed on the data), and the CI field is set to 0 to indicate that the encryption function is turned off for the data (that is, encryption processing is not performed on the data). The II field represents the second indication information. The II field is set to 1 to indicate that the integrity protection function is turned on for the data (that is, integrity protection processing is performed on the data), and the II field is set to 0 to indicate that the integrity protection function is turned off for the data (that is, integrity protection processing is not performed on the data).

In some embodiments, the node obtains a first index, and determines whether a function of at least one protocol entity is turned on based on the first index. The first index is used to determine a pattern about whether a function of each protocol entity in the at least one protocol entity is turned on. Specifically, a pattern corresponding to the first index is determined based on a first mapping relationship, and whether the function of the at least one protocol entity is turned on is determined based on the pattern corresponding to the first index. The first mapping relationship includes a pattern corresponding to each index of multiple indexes. Herein, the first index is carried in a packet header of the data.

Herein, alternatively, the function of the at least one protocol entity comprises at least one of a mapping function of the Qos flow of the SDAP entity to the bearer, an encryption and decryption function of the PDCP entity, an integrity protection function of the PDCP entity, and a segmentation function of the RLC entity.

As an example, the first mapping relationship may be configured by RRC signaling. A set of on/off (i.e., pattern) of a plurality of L2 functions is configured by RRC signaling, and an indication of on/off of each L2 function in the set is represented by an index. Table 1 below gives a turn-on/turn-off set of four L2 functions, and an integrity protection function and an encryption and decryption function are taken as examples of the L2 function, but are not limited thereto, and the L2 function may also include more or less other functions.

TABLE 1

| | | |
|---|---|---|
| Index 1 | Integrity protection function: on | Encryption and decryption |
| | | function: on |
| Index 2 | Integrity protection function: off | Encryption and decryption |
| | | function: on |
| Index 3 | Integrity protection function: on | Encryption and decryption |
| | | function: off |
| Index 4 | Integrity protection function: off | Encryption and decryption |
| | | function: off |

The above index is carried in the PDCP packet header of the data to indicate on/off of the L2 function, so that the L2 function can be dynamically set per data.

For a clear understanding of L2 function, it is listed in Table 2 below.

TABLE 2

| | |
|---|---|
| SDAP | mapping of Qos flow to DRB |
| | delivering in order |
| RLC | ARQ |
| | segmenting |
| | SN and reordering |
| PDCP | head compression |
| | integrity protection |
| | encryption and decryption |
| | SN and reordering functions |

Regardless of whether the SN is a PDCP SN or an RLC SN, the SN function is for packet reordering, duplication detection, feedback, etc. Therefore, the size of the SN cannot be changed dynamically or semi-statically per data.

The ARQ function of the RLC entity is used to indicate to the receiving end of the data whether feedback is required if the data is not received. If on or off of the ARQ function is indicated per data, the receiving end cannot determine whether the lost data needs feedback if the data is not received. Therefore, the on or off of the ARQ function cannot be dynamically or semi-statically indicated per data. Similarly, the mode of RLC cannot be changed dynamically or semi-statically per data.

The header compression function of PDCP entity is realized on the premise that the receiving end of data receives a complete packet to establish header compression context, and then the receiving end can receive a data packet for header compression and decompress a header according to the header compression context. In addition, there is no need to dynamically or semi-statically turn on or off the header compression function per data. Therefore, on or off of the head compression function cannot be dynamically or semi-statically indicated per data.

The encryption and decryption function and the integrity protection function of the PDCP entity may be dynamically or semi-statically indicated to be turned on or off per data.

In a second Mode, the protocol entity of the bearer includes a target entity, and the target entity has at least part of the functions of a PDCP entity and/or an RLC entity.

There is some functional redundancy in the SN and reordering functions of the PDCP entity and the RLC entity. Considering that the PDCP SN is not only used for data reordering, but also used for encryption and decryption and integrity protection, the functions of the PDCP entity and the RLC entity can be combined, and the combined functions can be realized by a newly defined target entity.

Herein, the target entity has at least some functions of the PDCP entity and/or the RLC entity. For example, the function of the target entity is a combination of the function of the PDCP entity and the function of the RLC entity. The target entity may be referred to as a packet process and link control (PPLC) entity, but of course, the target entity may have other names, which are not limited in the present disclosure.

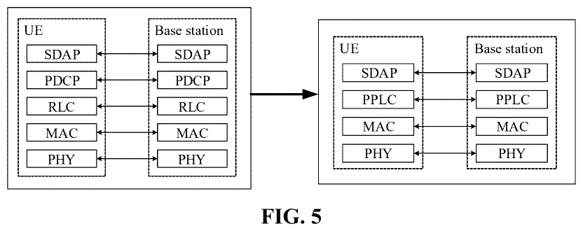

In one example, FIG. 5 shows a schematic diagram of protocol stacks on the UE side and the base station side, the UE and the base station have peer-to-peer protocol stacks. The protocol stacks of the PDCP entity and the RLC entity before merging are shown on the left side in FIG. 5, an SDAP entity exits above the PDCP entity and the RLC entity, and a media access control (MAC) entity and a physical (PHY) entity exist below the PDCP entity and the RLC entity. The protocol stack after the merging of the PDCP entity and the RLC entity is shown on the right side in FIG. 5. An SDAP entity exists above the PPLC entity and a MAC entity and a PHY entity exist below the PPLC entity.

In some embodiments, the target entity has a plurality of modes, and the plurality of modes include at least a first mode, a second mode and a third mode. Herein, the first mode may be referred to as an acknowledged mode (AM), the second mode may be referred to as an unacknowledged mode (UM), and the third mode may be referred to as a transparent mode (TM). Of course, the first mode, the second mode and the third mode may have other names, which is not limited in the present disclosure. Hereinafter, the functions of the target entity in the first mode, the second mode and the third mode will be described.

In Option 1, in some embodiments, the function of the target entity in the first mode includes at least one of the integrity protection function, the encryption and decryption function, the header compression function, the ARQ function, the serial number (SN) and reordering function, and the segmentation function. The function of the target entity in the second mode includes at least one of the integrity protection function, the encryption and decryption function, the header compression function, the SN and reordering function, and the segmentation function. The function of the target entity in the third mode includes at least one of the transparent function.

In Option 2, in some embodiments, the function of the target entity in the first mode includes at least one of the integrity protection function, the encryption and decryption function, the ARQ function, the SN and reordering function, and the segmentation function. The function of the target entity in the second mode includes at least one of the integrity protection function, the encryption and decryption function, the SN and reordering function, and the segmentation function. The function of the target entity in the third mode includes at least one of the transparent function. Herein, an SDAP entity exists on top of the target entity, and the SDAP entity has at least the header compression function.

In Option 3, in some embodiments, the function of the target entity in the first mode includes at least one of the ARQ function, the SN and reordering function, and the segmentation function. The function of the target entity in the second mode includes at least one of the SN and reordering function, and the segmentation function. The function of the target entity in the third mode includes at least one of the transparent function. Herein, an SDAP entity exists on top of the target entity, and the SDAP entity has at least one of the integrity protection function, the encryption and decryption function, and the header compression function.

In order to clear understand the functions of the target entity in the three modes, the functions are listed in Table 3 below.

TABLE 3

| | AM | UM | TM |
|---|---|---|---|
| Option 1 | Integrity protection | Integrity protection | Transparent |
| | encryption and | encryption and | |
| | decryption | decryption | |
| | head compression | head compression | |
| | ARQ | SN and reordering | |
| | SN and reordering | segmenting | |
| | segmenting | | |
| Option 2 | Integrity protection | Integrity protection | Transparent |
| | encryption and | encryption and | |
| | decryption | decryption | |
| | ARQ | SN and reordering | |
| | SN and reordering | segmenting | |
| | segmenting | | |
| Option 3 | ARQ | SN and reordering | Transparent |
| | SN and reordering | segmenting | |
| | segmenting | | |

In some embodiments, the protocol entities of the bearer include a target entity in a first mode and a target entity in a second mode. The target entity in the first mode is configured to process data having the first attribute information, and the target entity in the second mode is configured to process data having the second attribute information.

As an example, the first mode is the AM and the second mode is the UM. Alternatively, the first mode is the UM and the second mode is the AM.

In some embodiments, the first attribute information includes at least one of a first Qos attribute, a first data type, a first importance level, and the first data priority. The second attribute information includes at least one of a second Qos attribute, a second data type, a second importance level and the second data priority. Herein, the first Qos attribute includes, for example, that packet loss is not allowed or that ACK/NACK feedback is required. The second Qos attribute includes, for example, that packet loss is allowed or that ACK/NACK feedback is not required. Herein, the first data type is, for example, an I-frame. The second data type is, for example, a B-frame and/or a P-frame. The first importance level is, for example, a high importance level. The second importance level is, for example, a low importance level. The first data priority is, for example, a high priority. The second data priority is, for example, a low priority.

In some embodiments, the node determines a bearer identifier corresponding to a Qos flow according to a first mapping rule through a SDAP entity, determines a logical channel identifier and/or the bearer identifier corresponding to the data according to attribute information of each data in the Qos flow, and transmits the data to a target entity according to the bearer identifier and/or the logical channel identifier. The first mapping rule is a mapping rule of a Qos flow identifier to the bearer identifier. Alternatively, the node determines the bearer identifier and the logical channel identifier corresponding to each data in the Qos flow according to a second mapping rule through the SDAP entity, and delivers the data to a target entity according to the bearer identifier and the logical channel identifier. The second mapping rule is a mapping from <the Qos flow identifier, data attribute information> to <the bearer identifier, the logical channel identifier>.

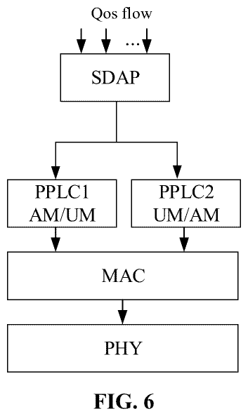

In one example, as shown in FIG. 6, the protocol entity of the bearer include two PPLC entities (i.e., PPLC entity 1 and PPLC entity 2), and the modes of the two PPLC entities are different. For example, the mode of PPLC entity 1 is the AM and the mode of PPLC entity 2 is the UM, or the mode of PPLC entity 1 is the UM and the mode of PPLC entity 2 is the AM. The data in a Qos flow has different attribute information, and the SDAP entity distributes the data to different PPLC entities according to the attribute information of the data. For example, the SDAP provides the data having the first attribute information to the PPLC entity in the mode AM, and the SDAP entity provides the data having the second attribute information to the PPLC entity in the mode UM. As an implementation, the SDAP entity determines a bearer identifier corresponding to the Qos flow according to a first mapping rule, and maps the Qos flow onto the bearer. Then, the SDAP entity determines the logical channel identifier and/or the bearer identifier corresponding to the data according to the attribute information of each data in the Qos flow, and maps the data to the corresponding PPLC entity. As another implementation, the second mapping rule is configured by the RRC, and the SDAP entity determines the bearer identity and the logical channel identity corresponding to each data in the Qos flow according to the second mapping rule, and maps the data to the corresponding PPLC entity.

In some embodiments, a target packet header corresponding to the data carries first indication information and/or second indication information. The first indication information is used to indicate whether the data is subject to encryption processing, the second indication information is used to indicate whether the data is subject to integrity protection processing, and the target packet header is a packet header corresponding to the target entity.

In one example, two pieces of indication information are carried in the PPLC packet header (i.e., the target packet header). The CI field represents the first indication information. The CI field is set to 1 to indicate that the encryption function is turned on for the data (that is, encryption processing is performed on the data), and the CI field is set to 0 to indicate that the encryption function is turned off for the data (that is, encryption processing is not performed on the data). The II field represents the second indication information. The II field is set to 1 to indicate that the integrity protection function is turned on for the data (that is, integrity protection processing is performed on the data), and the II field is set to 0 to indicate that the integrity protection function is turned off for the data (that is, integrity protection processing is not performed on the data).

In some embodiments, the node obtains a first index, and determines whether a function of at least one protocol entity is turned on based on the first index. The first index is used to determine a pattern about whether a function of each protocol entity in the at least one protocol entity is turned on. Specifically, a pattern corresponding to the first index is determined based on a first mapping relationship, and whether the function of the at least one protocol entity is turned on is determined based on the pattern corresponding to the first index. The first mapping relationship comprises a pattern corresponding to each index of multiple indexes. Herein, the first index is carried in a packet header of the data.

Herein, alternatively, the function of the at least one protocol entity comprises at least one of a mapping function of the Qos flow of the SDAP entity to the bearer, a encryption and decryption function of the target entity, an integrity protection function of the target entity, and a segmentation function of the target entity.

As an example, the first mapping relationship may be configured by RRC signaling. A set of on/off (i.e., pattern) of a plurality of L2 functions is configured by RRC signaling, and an indication of on/off of each L2 function in the set is represented by an index. An index is carried in the PPLC header of the data to indicate on/off of the L2 function, so that the L2 function can be dynamically set per data.

In some embodiments, the node performs at least one of the following processing on the data received from the upper layer through the target entity.

A first packet header is generated for the data, and the data is stored in a first buffer.

First processing is performed on the date in the first buffer. The first processing includes at least one of packet header compression processing, encryption processing, and integrity protection processing.

The data subjected to the first processing is stored in a second buffer.

Second processing is performed on the data in the second buffer or the data subjected to the first processing. The second processing includes segmentation processing.

A first packet header is added to the data subjected to the second processing or the data subjected to the first processing.

Further, optionally, the node further performs at least one of the following processing through the target entity.

The data to which the first packet header is added is stored in a third buffer.

The data in the third buffer is retransmitted when it is determined that the data needs to be retransmitted, or after the first packet header is removed from the data in the third buffer, then segmentation processing is performed on the data and the second packet header is added to the data, the data in the third buffer is retransmitted.

In some embodiments, the node performs at least one of the following processing on the data received from a bottom layer through the target entity.

Data is stored in a fourth buffer.

A first packet header or a second packet header is removed from the data in the fourth buffer.

At least one of the following processing is performed on the data from which the first packet header or the second packet header is removed: reorganization processing, reordering processing, decryption processing, integrity protection verification processing, and packet header decompression processing.

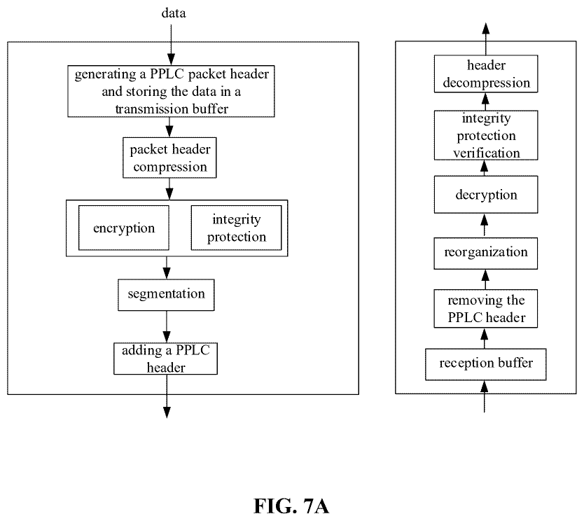

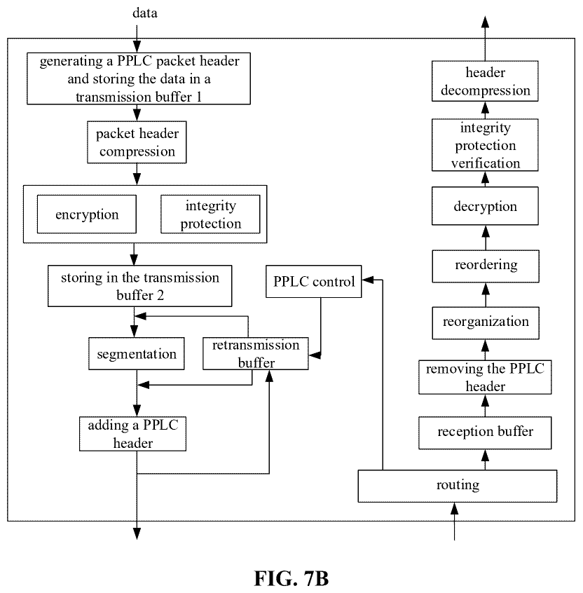

In one example, FIG. 7A schematically illustrates a data processing process based on a PPLC entity having no feedback retransmission mode. A processing process on the transmitting side includes the following operations. After data from an upper layer is received, a PPLC packet header is generated for the data and the data is stored in a transmission buffer. Packet header compression, encryption and integrity protection processing is performed on the data in the transmission buffer. A segmentation processing is performed on the data after the packet header compression, the encryption and integrity protection processing. A PPLC header is added for the data after the segmentation processing. The processing process on the receiving side includes the following operations. After the data from the bottom layer is received, the data is stored in a reception buffer. A processing of removing a PPLC header is performed on the data, reorganization processing is performed on the data after the PPLC header is removed, decryption processing is performed on the data after the reorganization processing, and integrity protection verification processing is performed on the data after the decryption processing; and header decompression processing is performed on the data after the integrity protection verification processing.

In one example, FIG. 7B schematically illustrates a data processing process based on a PPLC entity in a feedback retransmission mode. A processing process on the transmitting side includes the following operations. After data from an upper layer is received, a PPLC packet header is generated for the data and the data is stored in a transmission buffer 1, packet header compression, encryption and integrity protection processing is performed on the data in the transmission buffer 1. The data after the packet header compression, encryption and integrity protection processing is stored in the transmission buffer 2. Segmentation processing is performed on the data after the segmentation processing. A PPLC header is added to the data after the segmentation processing; and the data to which the PPLC packet header is added is stored in the retransmission buffer. When data is to be retransmitted in response to an instruction of the receiving side, data is obtained from the retransmission buffer, the PPCL header is removed from the data and a new PPLC packet header is added, or the PPLC packet header is removed from the data and then segmentation processing is performed the data, and a new PPLC packet header is added to the data. The processing process on the receiving side includes the following operations. The transmitting side is instructed to retransmit data if the retransmission instruction from the bottom layer is received. The data is stored in the reception buffer if the data from the bottom layer is received. A processing of removing the PPLC header is performed on the data. Reorganization processing is performed on the data after the PPLC header is removed. Reordering processing is performed on the data processed after the reorganization processing. Decryption processing is performed on the data after the reordering processing. Integrity protection verification processing is performed on the data after the decryption processing. Header decompression processing is performed on the data processed after the integrity protection verification processing.

It should note that, in the case where the L2 function can be set, the function of the PPLC entity is dynamically or semi-statically changed. Therefore, only a part of the steps (that is, a part corresponding to the function of the PPLC entity) shown in FIGS. 7-1 and 7-2 may be executed.

In some embodiments, the protocol stack of the node supports data duplication. Data duplication can be a data duplication based on carrier aggregation (CA) (i.e., CA based data duplication) or a data duplication based on DC (i.e., DC based data duplication). The data duplication is described below in connection with the target entity.

For CA based data duplication, the MAC entity of the node obtains first configuration information, and the first configuration information is used for configuring at least one of the following information about: data corresponding to a first logical channel requires duplication transmission, a repetition number of the duplication transmission, and a list of serving cells corresponding to each repetition; the MAC entity of the node duplicates multiple copies of the data based on the repetition number of the duplication transmission after the MAC entity of the node receives the data from the first logical channel from the target entity; multiplexing each copy of data into a MAC protocol data unit PDU in a scheduling authorization of the corresponding list of the serving cells based on the list of the serving cells corresponding to each repetition, and transmitting the MAC PDU under the authorization of the corresponding list of the serving cells.

Herein, the first configuration information may be configured by RRC. For CA based data duplication, the RRC configures a logical channel as CA based data duplication, and then configures the repetition number of the copy transmission to the MAC entity and the list of serving cells corresponding to each repetition. Compared with traditional CA based PDCP duplication, only one LCID is needed herein to meet this function.

For DC based data duplication, after the target entity of the node receives the data from the SDAP entity, the target entity duplicates the data, transmits a first copy of data to a MAC entity on a master cell group (MCG) side through a first MAC entity of the node, and transmits a second copy of data to a MAC entity on a SCG side through a second MAC entity of the node. The first copy of data received by the MAC entity on the MCG side and the second copy of data received by the MAC entity on the SCG side are associated with the same bearer identifier and different logical channel identifiers. Alternatively, after the target entity of the node receives the data from the SDAP entity, the target entity of the node transmits the data to the MAC entity on the MCG side through the first MAC entity of the node, or transmits the data to the MAC entity on the SCG side through the second MAC entity of the node. The data received by the MAC entity on the MCG side and the data received by the MAC entity on the SCG side are associated with the same bearer identifier and different logical channel identifiers.

Herein, the logical channel identifier associated with the second copy of data is used for the MAC entity on the SCG side to determine the bearer identifier associated with the second copy of data and forward the second copy of data to the target entity on the MCG side based on a tunnel corresponding to the bearer identifier. Alternatively, the logical channel identifier associated with the data is used for the MAC entity on the SCG side to determine the bearer identifier associated with the data and forward the data to the target entity on the MCG side based on a tunnel corresponding to the bearer identifier. Alternatively, the logical channel identifier associated with the data is used for the MAC entity on the MCG side to determine the bearer identifier associated with the data and to deliver the data to the target entity on the MCG side based on the bearer identifier.

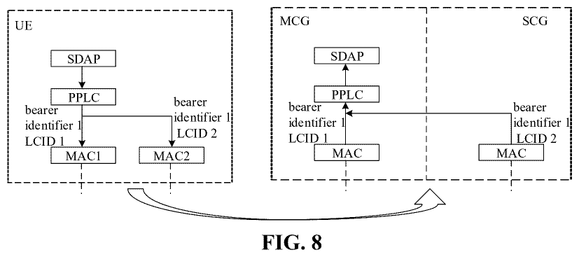

In one example, FIG. 8 schematically illustrates protocol stacks on the UE side and network side. The protocol stack on the UE side includes an SDAP entity, a PPLC entity, a MAC entity 1 and a MAC entity 2. The protocol stack on the network side includes an SDAP entity, a PPLC entity, an MCG MAC entity on the MCG side and an SCG MAC entity on the SCG side.

As one implementation mode, for the UE side, the PPLC entity copies data A after receiving the data A from the SDAP entity, transmits the data A through the MAC entity 1, and transmits the copied data A through the MAC entity 2. For the network side, the MCG MAC entity receives the data A and delivers the data A to the PPLC entity on the MCG side, and the SCG MAC entity receives the data A and delivers the data A to the PPLC entity on the MCG side. Herein, the MCG MAC entity receives the LCID 1 and the bearer identifier 1 associated with the data A, the SCG MAC entity receives the LCID 2 and the bearer identifier 1 associated with the data A, the SCG MAC entity determines that the data A is the duplicated data of the MCG side and/or determines the bearer or the PPLC entity to which the data A belongs according to the LCID 2 and the bearer identifier 1 associated with the data A, and forwards the data A to the PPLC entity of the MCG side through the GTP tunnel corresponding to the bearer identifier 1.

As another aspect, for the UE side, the PPLC entity transmits the data A through the MAC entity 1 or transmits the data A through the MAC entity 2 after receiving the data A from the SDAP entity. For the network side, the MCG MAC entity delivers the data A to the PPLC entity of the MCG side if the MCG MAC entity receives the data A. The SCG MAC entity delivers the data A to the PPLC entity on the MCG side if the SCG MAC entity receives the data A. Herein, the MCG MAC entity receives the LCID 1 and the bearer identifier 1 associated with the data A, the SCG MAC entity receives the LCID 2 and the bearer identifier 1 associated with the data A, the SCG MAC entity determines that the data A is the bearer or PPLC entity to which the data A belongs according to the LCID 2 and the bearer identifier 1 associated with the data A, and forwards the data A to the PPLC entity on the MCG side through the GTP tunnel corresponding to the bearer identifier 1.

It should be noted that the bearer in the embodiment of the present disclosure refers to a data bearer, and may also be referred to as a data radio bearer (DRB).

The technical solution of the embodiment of the present disclosure redefines the bearer, adapts to more complex business requirements and application scenarios of future communication standards (such as 6G), and achieves the purpose that the bearer flexibly adapts to service requirements and application scenarios.

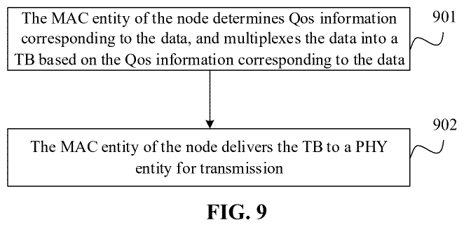

FIG. 9 is a second schematic flowchart of a method for processing data according to an embodiment of the present disclosure, and as shown in FIG. 9, the method for processing data includes the following operations 901 and 902.

At 901, the MAC entity of the node determines Qos information corresponding to the data, and multiplexes the data into a TB based on the Qos information corresponding to the data.

At 902, the MAC entity of the node delivers the TB to a PHY entity for transmission.

The technical solution of the embodiment of the present disclosure is applied to a node, which may be a network device or a terminal device.

In some embodiments, the node is a network device, the node receives data from a core network, and a packet header of the data carries Qos information corresponding to the data.

In some embodiments, the node is a terminal device, a MAC entity of the node receives data from an upper layer, and a packet header of the data carries Qos information corresponding to the data.

Herein, the Qos information may be a Qos flow id, a Qos id, or the like.

The Qos information is used to indicate a Qos requirement, the MAC entity of the node multiplexes data having the same Qos requirement into the same TB; or, the MAC entity of the node multiplexes data whose similarity of Qos requirements satisfies a specific condition into the same TB.

Herein, the MAC entity multiplexes data whose similarity of Qos requirements satisfies a specific condition into the same TB aims to multiplexing data with similar Qos requirements into the same TB by the MAC entity. Herein, the specific condition may be that the similarity is greater than or equal to a similarity threshold. The method of calculating the similarity is not limited in the present disclosure, and any method of calculating the similarity can be applied to the scheme of the present disclosure.

In some embodiments, the TB or the Qos information is associated with the first configuration information, and the first configuration information is used to configure at least one of: a maximum number of HARQ retransmissions corresponding to data, whether the data supports cross-carrier retransmission, and a maximum number of cross-carrier retransmissions of the data. Herein, the first configuration information is configured by RRC signaling or is specified in a protocol.

Based on this, the MAC entity of the node determines at least one of a maximum number of HARQ retransmissions of the data in the TB or data associated with the Qos information, whether the data supports cross-carrier retransmission, and a maximum number of cross-carrier retransmissions of the data, based on the first configuration information.

In some embodiments, when the MAC entity of the node determines that the data in the TB or the data associated with the Qos information reaches the maximum number of cross-carrier retransmissions, the node declares a radio link failure, and triggers an RRC connection reconstruction process.

It should be noted that the cross-carrier retransmission described above means that an initial carrier and a retransmission carrier of data are different carriers, or in different spectrum ranges, or have different center frequency points.

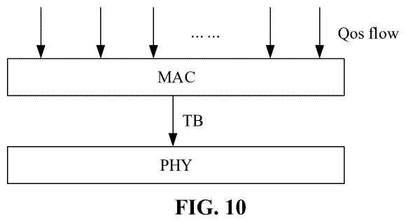

In an example, as shown in FIG. 10, the MAC entity may perform data scheduling based on the Qos. For downlink, a network device (such as a base station) receives data from the core network, and the MAC entity of the network device can distinguish the data of different Qos flows. For example, a packet header of each data from the core network carries a Qos flow id or Qos id, the Qos flow id or Qos id indicates the Qos requirement of the data, the network device distinguishes the data of different Qos flows according to the Qos flow id or the Qos id carried in the packet header of the data. For the uplink, the terminal device receives data from the upper layer, and similarly, the terminal device can distinguish the data of different Qos flows. The MAC entity multiplexes data having the same or similar Qos requirements into one TB and transmits the TB to the PHY entity for transmission. On the one hand, in order to meet the requirement of zero packet loss rate of data, the network side configures or specifies the maximum number of HARQ retransmissions for the TB where the data is carried, and additionally specifies that the data supports cross-carrier retransmission, and configures or specifies the maximum number of cross-carrier retransmissions. When the maximum number of cross-carrier retransmissions is reached, the terminal device declares a radio link failure, and triggers an RRC connection reconstruction process. On the other hand, each Qos flow id or the Qos id may be configured by RRC signaling to support cross-carrier retransmission, and the MAC entity determines the data to which cross-carrier retransmission may be performed based on the configuration of RRC signaling.

In some embodiments, the TB has at least one of the following characteristics. A packet header of each data multiplexed in the TB carries Qos information corresponding to the data; a packet header of each data multiplexed in the TB carries a serial number (SN) corresponding to the data; and a packet header of the TB carries the SN corresponding to the TB.

Herein, a plurality of pieces of data are multiplexed in the TB (that is, the MAC PDU), and a packet header (or sub-packet header) of each data carries Qos information (such as Qos flow id, Qos id) corresponding to the data, and the Qos information indicates the Qos flow to which the data belongs. In addition, the packet header (or sub-packet header) of each data may also carry an SN, and the SN indicates a serial number of the data in the Qos flow.

Herein, the packet header of the TB (that is, the MAC PDU) carries an SN, and the SN indicates a serial number of the TB in the MAC layer.

The preferred embodiments of the present disclosure have been described in detail above with reference to the accompanying drawings, but the present disclosure is not limited to the specific details in the above-described embodiments. Within the scope of the technical concept of the present disclosure, a variety of simple modifications can be made to the technical solutions of the present disclosure, and these simple modifications all belong to the scope of protection of the present disclosure. For example, various specific technical features described in the above-described embodiments may be combined in any suitable manner without contradiction, and various possible combinations are not be described separately in the present disclosure in order to avoid unnecessary repetition. For example, various embodiments of the present disclosure may be combined arbitrarily, and as long as they do not contradict the idea of the present disclosure, they should be regarded as the disclosure of the present disclosure as well. For another example, various embodiments described in the present disclosure and/or the technical features in the embodiments may be arbitrarily combined with the prior art, and the technical solution obtained after the combination should also fall within the scope of protection of the present disclosure.

It should also be understood that in various method embodiments of the present disclosure, the size of the serial numbers of the above-described processes does not mean an execution sequence, and the execution sequence of the processes should be determined by the function and internal logic thereof, and should not constitute any limitation on the implementation of the embodiments of the present disclosure. In addition, in the embodiment of the present disclosure, the terms “downlink”, “uplink” and “sidelink” indicate a transmission direction of a signal or data. The “downlink” indicates that the transmission direction of the signal or data is a first direction transmitted from a site to a user equipment of the cell, and the “uplink” indicates that the transmission direction of the signal or data is a second direction transmitted from the user equipment of the cell to the site. The “sidelink” indicates that a transmission direction of the signal or data is a third direction transmitted from the user equipment 1 to the user equipment 2. For example, “downlink signal” indicates that the transmission direction of the signal is the first direction. In addition, in the embodiment of the present disclosure, the term “and/or” is only one kind of association relationship describing an association object, and indicates that there may be three relationships. Specifically, A and/or B may represent three cases of A alone, A and B simultaneously, and B alone. In addition, the character “/” herein generally indicates that the associated objects before and after are in an “or” relationship.

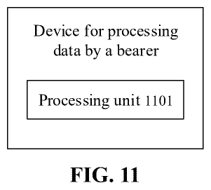

FIG. 11 is a first schematic diagram of a structure and composition of a device for processing data according to an embodiment of the present disclosure. The device is applied to a node, and the node has a bearer. As shown in FIG. 11, the device for processing data includes a processing unit 1101.

The processing unit 1101 is configured to process data by a protocol entity of a bearer. The bearer has at least one of the following characteristics.

At least two protocol entities of the bearer are protocol entities of the same type in different modes.

A function of at least one protocol entity of the bearer can change dynamically or semi-statically.

The protocol entity of the bearer includes a target entity, and the target entity has at least part of the functions of a PDCP entity and/or a RLC entity.

In some embodiments, the protocol entity of the bearer includes an RLC entity in a first mode and an RLC entity in a second mode.

The RLC entity in the first mode is configured to process data having the first attribute information.

The RLC entity in the second mode is configured to process data having the second attribute information.

In some embodiments, the protocol entity of the bearer further includes a PDCP entity that associates the RLC entity in the first mode and the RLC entity in the second mode.

In some embodiments, the target entity has a plurality of modes, and the plurality of modes include at least a first mode, a second mode and a third mode.

In some embodiments, the function of the target entity in the first mode includes at least one of the integrity protection function, the encryption and decryption function, the header compression function, the ARQ function, the SN and reordering function, and the segmentation function. The function of the target entity in the second mode includes at least one of the integrity protection function, the encryption and decryption function, the header compression function, the SN and reordering function, and the segmentation function. The function of the target entity in the third mode includes at least one of the transparent function.

In some embodiments, the function of the target entity in the first mode includes at least one of the integrity protection function, the encryption and decryption function, the ARQ function, the SN and reordering function, and the segmentation function. The function of the target entity in the second mode includes at least one of the integrity protection function, the encryption and decryption function, the SN and reordering function, and the segmentation function. The function of the target entity in the third mode includes at least one of the transparent function.

In some embodiments, an SDAP entity exists on top of the target entity, the SDAP entity has at least the header compression function.

In some embodiments, the function of the target entity in the first mode includes at least one of the ARQ function, the SN and reordering function, and the segmentation function. The function of the target entity in the second mode includes at least one of the SN and reordering function, and the segmentation function. The function of the target entity in the third mode includes at least one of the transparent function.

Herein, an SDAP entity exists on top of the target entity, and the SDAP entity has at least one of the integrity protection function, the encryption and decryption function, and the header compression function.

In some embodiments, when the protocol entity of the bearer includes a target entity, the processing unit 1101 is configured to perform at least one of the following processing on data received from the upper layer by the target entity.

A first packet header is generated for the data, and the data is stored in a first buffer.

First processing is performed on the date in the first buffer. The first processing includes at least one of packet header compression processing, encryption processing, and integrity protection processing.

The data subjected to the first processing is stored in a second buffer.

Second processing is performed on the data in the second buffer or the data subjected to the first processing. The second processing includes segmentation processing.

A first packet header is added to the data subjected to the second processing or the data subjected to the first processing.

In some embodiments, the processing unit 1101 is configured to further perform at least one of the following processing by the target entity.

The data to which the first packet header is added is stored in a third buffer.

The data in the third buffer is retransmitted when it is determined that the data needs to be retransmitted, or after the first packet header is removed from the data in the third buffer, then segmentation processing is performed on the data and the second packet header is added to the data, the data in the third buffer is retransmitted.

In some embodiments, when the protocol entity of the bearer includes a target entity, the processing unit 1101 is configured to perform at least one of the following processing on the data received from the bottom layer by the target entity.

Data is stored in a fourth buffer.

A first packet header or a second packet header is removed from the data in the fourth buffer.

At least one of the following processing is performed on the data from which the first packet header or the second packet header is removed: reorganization processing, reordering processing, decryption processing, integrity protection verification processing, and packet header decompression processing.

In some embodiments, the protocol entity of the bearer includes a target entity in a first mode and a target entity in a second mode. The target entity in the first mode is configured to process data having the first attribute information, and the target entity in the second mode is configured to process data having the second attribute information.

In some embodiments, the processing unit 1101 is configured to determine a bearer identifier corresponding to a Qos flow according to a first mapping rule through a SDAP entity, determine a logical channel identifier and/or the bearer identifier corresponding to the data according to attribute information of each data in the Qos flow, and transmits the data to a target entity according to the bearer identifier and/or the logical channel identifier. The first mapping rule is a mapping rule of a Qos flow identifier to the bearer identifier. Alternatively, the processing unit 1101 is configured to determine the bearer identifier and the logical channel identifier corresponding to each data in the Qos flow according to a second mapping rule through the SDAP entity, and deliver the data to a target entity according to the bearer identifier and the logical channel identifier. The second mapping rule is a mapping from <the Qos flow identifier, data attribute information> to <the bearer identifier, the logical channel identifier>.

In some embodiments, when the protocol entity of the bearer includes the target entity, the method further includes the following operations. The processing unit 1101 is configured to obtain first configuration information through the MAC entity, and the first configuration information is used for configuring at least one of the following information about: data corresponding to a first logical channel requires duplication transmission, a repetition number of the duplication transmission, and a list of serving cells corresponding to each repetition; the MAC entity of the node duplicates multiple copies of the data based on the repetition number of the duplication transmission after the MAC entity of the node receives the data from the first logical channel from the target entity; multiplexing each copy of data into a MAC protocol data unit PDU in a scheduling authorization of the corresponding list of the serving cells based on the list of the serving cells corresponding to each repetition, and transmitting the MAC PDU under the authorization of the corresponding list of the serving cells.

In some embodiments, when the bearer protocol entity includes the target entity, the method further includes the following operations. After the target entity receives the data from the SDAP entity, the processing unit 1101 is configured to duplicate the data, transmit a first copy of data to a MAC entity on a master cell group (MCG) side through a first MAC entity of the node, and transmit a second copy of data to a MAC entity on a SCG side through a second MAC entity of the node. The first copy of data received by the MAC entity on the MCG side and the second copy of data received by the MAC entity on the SCG side are associated with the same bearer identifier and different logical channel identifiers. Alternatively, after the target entity receives the data from the SDAP entity, the target entity transmits the data to the MAC entity on the MCG side through the first MAC entity of the node or transmits the data to the MAC entity on the SCG side through the second MAC entity of the node. The data received by the MAC entity on the MCG side and the data received by the MAC entity on the SCG side are associated with the same bearer identifier and different logical channel identifiers.

In some embodiments, the logical channel identifier associated with the second copy of data is used for the MAC entity on the SCG side to determine the bearer identifier associated with the second copy of data and forward the second copy of data to the target entity on the MCG side based on a tunnel corresponding to the bearer identifier. Alternatively, the logical channel identifier associated with the data is used for the MAC entity on the SCG side to determine the bearer identifier associated with the data and forward the data to the target entity on the MCG side based on a tunnel corresponding to the bearer identifier.

Alternatively, the logical channel identifier associated with the data is used for the MAC entity on the MCG side to determine the bearer identifier associated with the data and to deliver the data to the target entity on the MCG side based on the bearer identifier.

In some embodiments, a PDCP packet header or a target packet header corresponding to the data carries first indication information and/or second indication information. The first indication information indicates whether the data is subject to encryption processing, and the second indication information indicates whether the data is subject to integrity protection processing. The PDCP packet header is a packet header corresponding to the PDCP entity, and the target packet header is a packet header corresponding to the target entity.

In some embodiments, the processing unit 1101 is configured to obtain a first index, and determine whether a function of at least one protocol entity is turned on based on the first index. The first index is used to determine a pattern about whether a function of each protocol entity in the at least one protocol entity is turned on.

In some embodiments, the processing unit 1101 is configured to determine a pattern corresponding to the first index based on a first mapping relationship, and determine whether the function of the at least one protocol entity is turned on based on the pattern corresponding to the first index. The first mapping relationship includes a pattern corresponding to each index of multiple indexes.

In some embodiments, the function of the at least one protocol entity includes at least one of a mapping function of the Qos flow of the SDAP entity to the bearer, an encryption and decryption function of the PDCP entity, an integrity protection function of the PDCP entity, and a segmentation function of the RLC entity.

In some embodiments, the functionality of the at least one protocol entity includes at least one of a mapping function of the Qos flow of the SDAP entity to the bearer, an encryption and decryption function of the target entity, an integrity protection function of the target entity, and a segmentation function of the target entity.

In some embodiments, the first index is carried in a packet header of the data.

Those skilled in the art should understand that the related description of the above-described device for processing data according to the embodiment of the present disclosure can be understood with reference to the related description of the method for processing data according to the embodiment of the present disclosure.

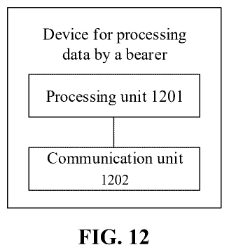

FIG. 12 is a second schematic diagram of the structure and composition of a device for processing data according to an embodiment of the present disclosure. The device is applied to a node, and the node has a MAC entity and a PHY entity. As shown in FIG. 12, the device for processing data includes a processing unit 1201.

The processing unit 1201 is configured to determine Qos information corresponding to the data through the MAC entity, and multiplex the data into a TB based on the Qos information corresponding to the data; deliver the TB to a PHY entity for transmission.

In some embodiments, the node is a network device, and the device further includes a communication unit 1202.

The communication unit 1202 is configured to receive data from a core network, and a packet header of the data carries Qos information corresponding to the data.

In some embodiments, the node is a terminal device, a MAC entity of the node receives data from an upper layer, and a packet header of the data carries Qos information corresponding to the data.

In some embodiments, the Qos information indicates a Qos requirement. The processing unit 1201 is configured to multiplex data having the same Qos requirement into the same TB through the MAC entity; or, multiplex data whose similarity of Qos requirements satisfies a specific condition into the same TB.

In some embodiments, the TB or the Qos information is associated with first configuration information, and the first configuration information is used to configure at least one of: a maximum number of HARQ retransmissions corresponding to data, whether the data supports cross-carrier retransmission, and a maximum number of cross-carrier retransmissions of the data.

In some embodiments, the first configuration information is configured by RRC signaling or is specified in a protocol.

In some embodiments, the processing unit 1201 is configured to determine at least one of a maximum number of HARQ retransmissions of the data in the TB or data associated with the Qos information, whether the data supports cross-carrier retransmission, and a maximum number of cross-carrier retransmissions of the data, based on the first configuration information.

In some embodiments, the processing unit 1201 is configured to, when it is determined that the data in the TB or the data associated with the Qos information reaches the maximum number of cross-carrier retransmissions, declare a radio link failure, and triggers an RRC connection reconstruction process.

In the above solution, the cross-carrier retransmission means that an initial carrier and a retransmission carrier of data are different carriers, or in different spectrum ranges, or have different center frequency points.

In some embodiments, the TB has at least one of the following characteristics. A packet header of each data multiplexed in the TB carries Qos information corresponding to the data; a packet header of each data multiplexed in the TB carries a SN corresponding to the data; and a packet header of the TB carries the SN corresponding to the TB.

Those skilled in the art should understand that the related description of the above-described device for processing data according to the embodiment of the present disclosure can be understood with reference to the related description of the method for processing data according to the embodiment of the present disclosure.

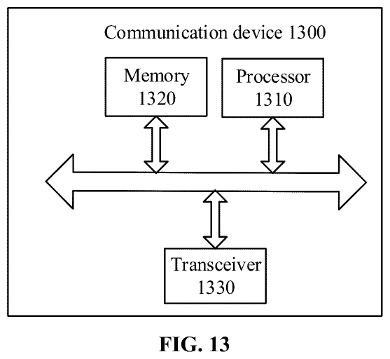

FIG. 13 is a schematic structural diagram of a communication device 1300 according to an embodiment of the present disclosure. The communication device may be a terminal device or a network device. The communication device 1300 illustrated in FIG. 13 includes a processor 1310, and the processor 1310 can invoke and execute a computer program from a memory to implement the method in the embodiment of the present disclosure.

Alternatively, as shown in FIG. 13, the communication device 1300 may further include a memory 1320. The processor 1310 may invoke and execute a computer program from the memory 1320 to implement the method in the embodiment of the present disclosure.

The memory 1320 may be a separate device independent of the processor 1310 or may be integrated in the processor 1310.

Alternatively, as shown in FIG. 13, the communication device 1300 may further include a transceiver 1330, and the processor 1310 may control the transceiver 1330 to communicate with other devices, specifically, may transmit information or data to other devices, or receive information or data transmitted by other devices.

The transceiver 1330 may include a transmitter and a receiver. The transceiver 1330 may further include antennas, and the number of antennas may be one or more.

Optionally, the communication device 1300 may be a network device according to the embodiment of the present disclosure, and the communication device 1300 may implement corresponding flows implemented by the network device in each method according to the embodiment of the present disclosure, and will not be described herein for the sake of brevity.

Optionally, the communication device 1300 may specifically be a mobile terminal/terminal device according to the embodiment of the present disclosure, and the communication device 1300 may implement corresponding flows implemented by the mobile terminal/terminal device in each method according to the embodiment of the present disclosure, and will not be described herein for the sake of brevity.

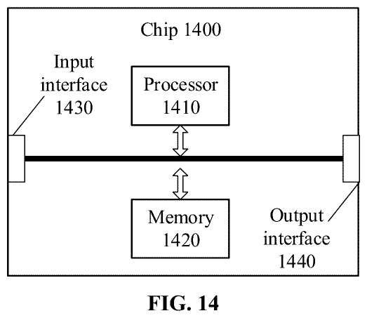

FIG. 14 is a schematic structural diagram of a chip according to an embodiment of the present disclosure. The chip 1400 shown in FIG. 14 includes a processor 1410, and the processor 1410 can invoke and execute a computer program from a memory to implement the method in the embodiment of the present disclosure.

Alternatively, as shown in FIG. 14, the chip 1400 may further include a memory 1420. The processor 1410 may invoke and execute a computer program from the memory 1420 to implement the method in the embodiment of the present disclosure.

The memory 1420 may be a separate device independent of the processor 1410 or may be integrated in the processor 1410.

Alternatively, the chip 1400 may further include an input interface 1430. The processor 1410 may control the input interface 1430 to communicate with other devices or chips, specifically, may acquire information or data transmitted by other devices or chips.

Alternatively, the chip 1400 may further include an output interface 1440. The processor 1410 may control the output interface 1440 to communicate with other devices or chips, specifically, may output information or data to other devices or chips.

Alternatively, the chip can be applied to the network device in the embodiment of the present disclosure, and the chip can implement the corresponding flows implemented by the network device in each method of the embodiment of the present disclosure, and will not be repeated here for the sake of brevity.

Alternatively, the chip can be applied to the mobile terminal/terminal device in the embodiment of the present disclosure, and the chip can implement the corresponding flows implemented by the mobile terminal/terminal device in each method of the embodiment of the present disclosure, and will not be repeated here for the sake of brevity.

It should be understood that the chip mentioned in the embodiments of the present disclosure may also be referred to as a system-on-chip, system chip, or a chip system on chip.

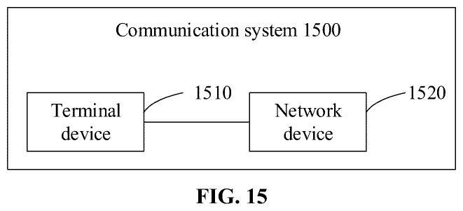

FIG. 15 is a schematic block diagram of a communication system 1500 according to an embodiment of the present disclosure. As shown in FIG. 15, the communication system 1500 includes a terminal device 1510 and a network device 1520.

The terminal device 1510 may be used to implement the corresponding functions implemented by the terminal device in the above-described method, and the network device 1520 may be used to implement the corresponding functions implemented by the network device in the above-described method, and will not be repeated here for the sake of brevity.

It should be understood that the processor of the embodiment of the present disclosure may be an integrated circuit chip having signal processing capabilities. In the implementation process, the steps of the above-described method embodiments may be completed by integrated logic circuits of hardware or instructions in the form of software in the processor. The processor described above may be a general-purpose processor, a digital signal processor (DSP), an application specific integrated circuit (ASIC), a field programmable gate array (FPGA) or other programmable logic device, a discrete gate or transistor logic device, or a discrete hardware component. The methods, steps, and logical block diagrams disclosed in the embodiments of the present disclosure may be implemented or executed. The general purpose processor may be a microprocessor or the processor may be any conventional processor or the like. The steps of the method disclosed in the embodiment of the present disclosure can be directly completed by a hardware decoding processor, or completed by a combination of hardware and software modules in the decoding processor. The software module may be located in a mature storage medium in the art, such as a random access memory, a flash memory, a read-only memory, a programmable read-only memory, or an electrically erasable programmable read-only memory, a register, etc. The storage medium is located in the memory, and the processor reads the information in the memory, and completes the steps of the above method in combination with the hardware thereof.

It is understood that the memory in the embodiments of the present disclosure may be a volatile memory or a non-volatile memory, or may include both volatile and non-volatile memory. The non-volatile memory may be a read-only memory (ROM), a programmable ROM (PROM), an erasable PROM (EPROM), an electrically EPROM (EEPROM), or a flash memory. The volatile memory may be a random access memory (RAM), which serves as an external buffer. By way of illustration, but not limitation, many forms of RAM are available, such as a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM) and a direct Rambus RAM (DR RAM). It should be noted that the memory of the systems and methods described herein is intended to include, but is not limited to, these and any other suitable type of memory.

It should be understood that the above memory is illustrative but is not limited thereto For example, the memory in the embodiments of the present disclosure may also be the SRAM, the DRAM, the SDRAM, the DDR SDRAM, the ESDRAM, the SLDRAM and the DR RAM, etc. That is, the memory in the embodiments of the present disclosure is intended to include, but is not limited to, these and any other suitable type of memory.

The embodiments of the present disclosure also provide a computer-readable storage medium for storing a computer program.

Optionally, the computer-readable storage medium may be applied to the network device in the embodiment of the present disclosure, and the computer program causes the computer to execute the corresponding flows implemented by the network device in each method in the embodiment of the present disclosure, and will not be repeated here for the sake of brevity.

Optionally, the computer-readable storage medium may be applied to the mobile terminal/terminal device in the embodiment of the present disclosure, and the computer program causes the computer to execute the corresponding flow implemented by the mobile terminal/terminal device in each method of the embodiment of the present disclosure, and will not be repeated here for the sake of brevity.

The embodiments of the present disclosure also provide a computer program product including computer program instructions.

Optionally, the computer program product may be applied to the network device in the embodiment of the present disclosure, and the computer program instruction causes the computer to execute the corresponding flows implemented by the network device in each method in the embodiment of the present disclosure, and will not be repeated here for the sake of brevity.

Optionally, the computer program product may be applied to the mobile terminal/terminal device in the embodiment of the present disclosure, and the computer program instruction causes the computer to execute the corresponding flows implemented by the mobile terminal/terminal device in each method of the embodiment of the present disclosure, and will not be repeated here for the sake of brevity.

The embodiments of the present disclosure also provide a computer program.

Optionally, the computer program may be applied to the network device in the embodiment of the present disclosure, and the computer program when run on the computer, enables the computer to execute the corresponding flows implemented by the network device in each method of the embodiment of the present disclosure, and will not be repeated here for the sake of brevity.

Optionally, the computer program may be applied to the mobile terminal/terminal device in the embodiment of the present disclosure, and the computer program when run on the computer, enables the computer to execute the corresponding flows implemented by the mobile terminal/terminal device in each method of the embodiment of the present disclosure, and will not be repeated here for the sake of brevity.

Those skilled in the art will appreciate that the elements and algorithmic steps of the various examples described in connection with the embodiments disclosed herein may be implemented in electronic hardware, or a combination of computer software and electronic hardware. Whether these functions are performed in hardware or software depends on the specific application and design constraints of the technical solution. Those skilled in the art may use different methods for implementing the described functions for each particular application, but such implementations should not be considered beyond the scope of the present disclosure.

Those skilled in the art can clearly understand that, for convenience and brevity of the description, regarding the specific operation processes of the systems, devices, and units described above, reference may be made to the corresponding processes in the aforementioned method embodiments, and will not be repeated here.

In several embodiments provided herein, it should be understood that the disclosed systems, device, and methods may be implemented in other ways. For example, the device embodiments described above are merely schematic, for example, the division of units is only one logical function division, and there may be other division manners in actual implementation. For example, multiple units or components may be combined or integrated into another system, or some features may be ignored or not implemented. In addition, the coupling or direct coupling or communication connection shown or discussed may be an indirect coupling or communication connection through some interface, device or unit, which may be electrical, mechanical or otherwise.

The units described as separate units may or may not be physically separated, and the units displayed as units may or may not be physical units, that is, they may be located at the same place or may be distributed over a plurality of network units. Some or all of the units may be selected according to actual needs to achieve the purpose of the solution of the present embodiment.

In addition, all functional units in each embodiment of the present disclosure may be integrated in one processing unit, or each function unit may be physically present alone, or two or more units may be integrated in one unit.

The functions may be stored in a computer-readable storage medium if implemented in the form of software functional units and sold or used as independent products. Based on this understanding, the technical solution of the present disclosure essentially or a part of the technical solution that contributes to the prior art or a part of the technical solution may be embodied in the form of a software product, the computer software product is stored in a storage medium, includes several instructions for causing a computer device (which may be a personal computer, server, or network device, etc.) to perform all or part of the steps of the method described in various embodiments of the present disclosure. The storage medium includes a USB disk, a removable hard disk, a read-only memory (ROM), a random access memory (RAM), a magnetic disk, or an optical disk or a medium capable of storing program codes.

The foregoing is merely a specific embodiment of the present disclosure, but the scope of protection of the present disclosure is not limited thereto, and changes or substitutions easily conceived by any person skilled in the art within the technical scope disclosed in the present disclosure should be covered within the scope of protection of the present disclosure. Therefore, the scope of protection of the present disclosure should be subject to the scope of protection of the claims.

1. A method of processing data, comprising:
processing, by a node, data through a protocol entity of a bearer, wherein the bearer has at least one of following characteristics:
at least two protocol entities of the bearer are protocol entities of a same type in different modes;
a function of at least one protocol entity of the bearer is able to change dynamically or semi-statically; and
the protocol entity of the bearer comprises a target entity, and the target entity has at least part of functions of a packet data convergence protocol (PDCP) entity and/or a radio link control (RLC) entity.

2. The method of claim 1, wherein the protocol entity of the bearer comprise an RLC entity in a first mode and an RLC entity in a second mode,
the RLC entity in the first mode is configured to process data having first attribute information; and
the RLC entity in the second mode is configured to process data having second attribute information.

3. The method of claim 2, wherein the protocol entity of the bearer further comprises the PDCP entity, and the PDCP entity is associated with the RLC entity in the first mode and the RLC entity in the second mode.

4. The method of claim 1, wherein the target entity has a plurality of modes, and the plurality of modes comprise at least a first mode, a second mode and a third mode.

5. The method of claim 4, wherein,
a function of the target entity in the first mode comprises at least one of an integrity protection function, an encryption and decryption function, a header compression function, an automatic repeat-request (ARQ) function, a serial number (SN) and reordering function, and a segmentation function;
a function of the target entity in the second mode comprises at least one of the integrity protection function, the encryption and decryption function, the header compression function, the SN and reordering function and the segmentation function; and
a function of the target entity in the third mode comprises at least one of a transparent function.

6. The method of claim 4, wherein,
a function of the target entity in the first mode comprises at least one of an integrity protection function, an encryption and decryption function, an automatic repeat-request (ARQ) function, a serial number (SN) and reordering function and a segmentation function;
a function of the target entity in the second mode comprises at least one of the integrity protection function, the encryption and decryption function, the SN and reordering function and the segmentation function; and
a function of the target entity in the third mode comprises at least one of a transparent function.

7. The method of claim 6, wherein a service data adaption protocol (SDAP) entity is on top of the target entity, and the SDAP entity has at least a header compression function.

8. The method of claim 4, wherein,
a function of the target entity in the first mode comprises at least one of an automatic repeat-request (ARQ) function, a serial number (SN) and reordering function, and a segmentation function;
a function of the target entity in the second mode comprises at least one of the SN and reordering function and the segmentation function; and
a function of the target entity in the third mode comprises at least one of a transparent function,
wherein a service data adaption protocol (SDAP) entity is on top of the target entity, and the SDAP entity has at least one of an integrity protection function, an encryption and decryption function and a header compression function.

9. The method of claim 1, wherein in case the protocol entity of the bearer comprises the target entity, the processing, by the node, the data through protocol entity of the bearer comprises:
performing, by the node, at least one of following processing on data received from an upper layer through the target entity:
generating a first packet header for the data, and storing the data in a first buffer;
performing first processing on the data in the first buffer, wherein the first processing comprises at least one of packet header compression processing, encryption processing and integrity protection processing;
storing the data after the first processing in a second buffer;
performing second processing on the data in the second buffer or the data after the first processing, wherein the second processing comprises segmentation processing; and
adding a first packet header to the data after the second processing or the data after the first processing,
wherein the node further performs at least one of following processing on the data received from the upper layer through the target entity:
storing the data to which the first packet header is added in a third buffer; and
when it is determined that the data is to be retransmitted,
retransmitting the data in the third buffer, or
removing the first packet header of the data in the third buffer, segmenting the data and adding the second packet header onto the data, and retransmitting the data in the third buffer.

10. The method of claim 1, wherein in case the protocol entity of the bearer comprises the target entity, the processing, by the node, the data through protocol entity of the bearer comprises:
performing, by the node, at least one of following processing on the data received from a bottom layer through the target entity:
storing data in a fourth buffer;
removing a first packet header or a second packet header of the data in the fourth buffer; and
performing at least one of following processing on the data after the first packet header or the second packet header is removed: reorganization processing, reordering processing, decryption processing, integrity protection verification processing, and packet header decompression processing.

11. A communication device comprising a processor and a memory for storing a computer program,
wherein the processor is configured for invoking and executing the computer program stored in the memory to cause the communication device to:
process data through a protocol entity of a bearer, the bearer having at least one of following characteristics:
at least two protocol entities of the bearer are protocol entities of a same type in different modes;
a function of at least one protocol entity of the bearer is able to change dynamically or semi-statically; and
the protocol entity of the bearer comprises a target entity, and the target entity has at least part of functions of a packet data convergence protocol (PDCP) entity and/or a radio link control (RLC) entity.

12. The communication device of claim 11, wherein the protocol entity of the bearer comprise an RLC entity in a first mode and an RLC entity in a second mode,
the RLC entity in the first mode is configured to process data having first attribute information; and
the RLC entity in the second mode is configured to process data having second attribute information.

13. The communication device of claim 12, wherein the protocol entity of the bearer further comprises a PDCP entity, and the PDCP entity is associated with the RLC entity in the first mode and the RLC entity in the second mode.

14. The communication device of claim 11, wherein the target entity has a plurality of modes, and the plurality of modes comprise at least a first mode, a second mode and a third mode.

15. The communication device of claim 14, wherein,
a function of the target entity in the first mode comprises at least one of an integrity protection function, an encryption and decryption function, a header compression function, an automatic repeat-request (ARQ) function, a serial number (SN) and reordering function, and a segmentation function;
a function of the target entity in the second mode comprises at least one of the integrity protection function, the encryption and decryption function, the header compression function, the SN and reordering function and the segmentation function; and
a function of the target entity in the third mode comprises at least one of a transparent function.

16. The communication device of claim 14, wherein,
a function of the target entity in the first mode comprises at least one of an integrity protection function, an encryption and decryption function, an automatic repeat-request (ARQ) function, a serial number (SN) and reordering function and a segmentation function;
a function of the target entity in the second mode comprises at least one of the integrity protection function, the encryption and decryption function, the SN and reordering function and the segmentation function; and
a function of the target entity in the third mode comprises at least one of a transparent function,
wherein a service data adaption protocol (SDAP) entity is on top of the target entity, and the SDAP entity has at least a header compression function.

17. The communication device of claim 13, wherein,
a function of the target entity in the first mode comprises at least one of an automatic repeat-request (ARQ) function, a serial number (SN) and reordering function, and a segmentation function;
a function of the target entity in the second mode comprises at least one of the SN and reordering function and the segmentation function; and
a function of the target entity in the third mode comprises at least one of a transparent function,
wherein a service data adaption protocol (SDAP) entity is on top of the target entity, and the SDAP entity has at least one of an integrity protection function, an encryption and decryption function and a header compression function.

18. The communication device of claim 11, wherein in case the protocol entity of the bearer comprises the target entity, the processor is configured for invoking and executing the computer program stored in the memory to cause the communication device to:
perform at least one of following processing on data received from an upper layer through the target entity:
generating a first packet header for the data, and storing the data in a first buffer;
performing first processing on the data in the first buffer, wherein the first processing comprises at least one of packet header compression processing, encryption processing and integrity protection processing;
storing the data after the first processing in a second buffer;
performing second processing on the data in the second buffer or the data after the first processing, wherein the second processing comprises segmentation processing; and
adding a first packet header to the data after the second processing or the data after the first processing,
wherein the processor is configured for invoking and executing the computer program stored in the memory to cause the communication device to perform at least one of following processing on the data received from the upper layer through the target entity:
storing the data to which the first packet header is added in a third buffer; and
when it is determined that the data is to be retransmitted,
retransmitting the data in the third buffer, or
removing the first packet header of the data in the third buffer, segmenting the data and adding the second packet header onto the data, and retransmitting the data in the third buffer.

19. The communication device of claim 11, wherein in case the protocol entity of the bearer comprises the target entity, the processor is configured for invoking and executing the computer program stored in the memory to cause the communication device to:
perform at least one of following processing on the data received from a bottom layer through the target entity:
storing data in a fourth buffer;
removing a first packet header or a second packet header of the data in the fourth buffer; and
performing at least one of following processing on the data after the first packet header or the second packet header is removed: reorganization processing, reordering processing, decryption processing, integrity protection verification processing, and packet header decompression processing.

20. A chip comprising a processor for invoking and executing a computer program from a memory to enable a device on which the chip is mounted to:
process data through a protocol entity of a bearer, wherein the bearer has at least one of following characteristics:
at least two protocol entities of the bearer are protocol entities of a same type in different modes;
a function of at least one protocol entity of the bearer is able to change dynamically or semi-statically; and
the protocol entity of the bearer comprises a target entity, and the target entity has at least part of functions of a packet data convergence protocol (PDCP) entity and/or a radio link control (RLC) entity.
